(19) United States
(12) Patent Application Publication
(10) Pub. No.: US 2020/0134304 A1
(43) Pub. Date: Apr. 30, 2020

(54) HEADGEAR IDENTIFICATION SYSTEM

(71) Applicant: Jesse Limones, JR., Loraine, TX (US)

(72) Inventor: Jesse Limones, JR., Loraine, TX (US)

(21) Appl. No.: 16/281,942

(22) Filed: Feb. 21, 2019

Related U.S. Application Data
(60) Provisional application No. 62/749,980, filed on Oct. 24, 2018.

(51) Int. Cl. G06K 9/00; G06K 9/62; B65D 41/34

(52) U.S. Cl. CPC G06K 9/00362; B65D 41/34; G06K 9/6267

(57) ABSTRACT

A headgear identification enables a user to quickly identify their personal cap or hat among others of similar or identical appearance. A cover is fitted over the button of the cap and carries markings, colors or other identification means to allow for personalization of the cap. The cover also could attach to other features of other types of headgear in a similar fashion.

### BACKGROUND

### 1. Field of the Invention

The present invention relates generally to headgear systems, and more specifically, to systems and methods of differentiating or personalizing baseball caps.

### 2. Description of Related Art

Headgear systems are well known in the art and are effective means to protect the head, face and other nearby areas from injury, provide aesthetic expression or team identification. For example, FIG. 1 depicts a conventional baseball cap 101 having a crown 103 attached to a bill 105. The crown 103 having panels 107 joined at the top by a button 109. During use, the crown 103 is placed on the head of a user so the bill 105 is generally over the face of the user. A common use being a part of a sports teams uniform. In which case all of the players have the same cap 101.

One of the problems commonly associated with cap 101 is its limited efficiency. For example, when a baseball team enters the dugout it is common for the players to remove their caps 101 and place them on benches, hooks or the like. When it is time to exit the dugout the players must determine which cap is theirs and while names are often written on the inside of the caps, each cap must be evaluated to identify the owner causing delays in the game, or use of another players cap 101.

Accordingly, although great strides have been made in the area of baseball caps and other headgears systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a side view of a common baseball cap;

FIGS. 2A and 2B are side views of a headgear identification system in accordance with a preferred embodiment of the present application;

FIG. 3 is a cross-sectional side view of the cover of FIGS. 2A and 2B

FIG. 4 is a top view of the cover of FIG. 3;

FIG. 5 is a flowchart of the preferred method of use of the system of FIGS. 2A and 2B; and

FIG. 6 is an exploded side view of an alternative embodiment of the system of FIGS. 2A and 2B.

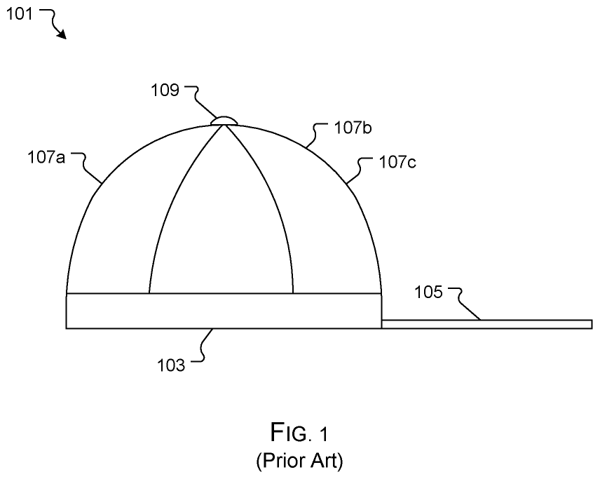

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional baseball caps. Specifically, the invention of the present application enables the quick identification of a user's cap without impacting the overall appearance of the cap. This and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

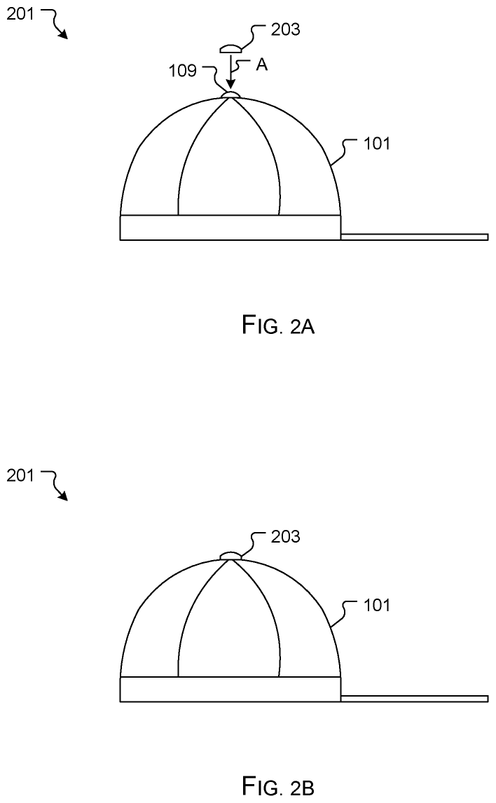

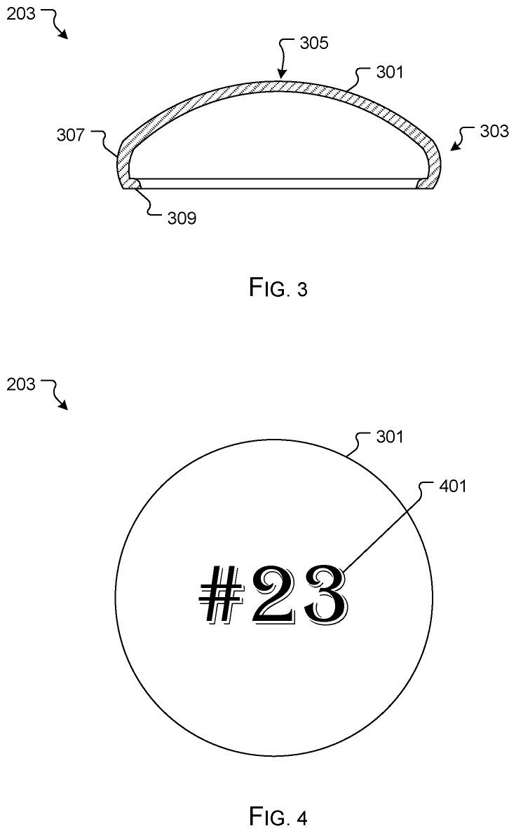

Referring now to the drawings wherein like reference characters identify corresponding or similar elements throughout the several views, FIGS. 2A and 2B depict side views of a headgear identification system in accordance with a preferred embodiment of the present application. It will be appreciated that system 201 overcomes one or more of the above-listed problems commonly associated with conventional baseball caps.

In the contemplated embodiment, system 201 includes a cover 203 configured to fit over the button 109 of a baseball cap 101 as indicated by motion A. The cover 203, as depicted in FIG. 3, includes a body 301 where the outer edge 303 is curved back toward the center 305 of the body 301 forming a wall 307 with a lip 309. It is also contemplated that other means of attaching the cover 203 to the button 109 could be used, such as magnetic force.

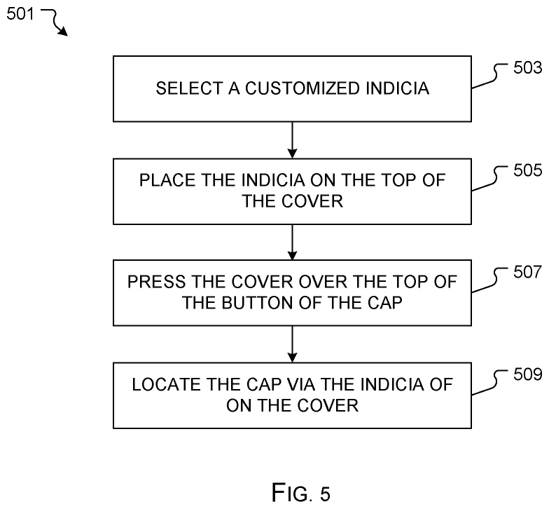

Referring now to FIG. 4, the cover 203 is depicted for clarity. The cover having an indicia 401 on the top surface 403. It is contemplated that the indicia 401 could be alphanumeric characters, images, team logos, colors or the like.

In use, a unique or individualized indicia 401 is selected for each user and attached to the cover 203. The cover 203 is then placed over and pressed down on the button 109. Each cap 101 is now easily identifiable when next to other similar or identical caps.

It should be appreciated that one of the unique features believed characteristic of the present application is that indicia 401 is adaptable or customizable for each user so that the unique covers 203 are attached to identical caps.

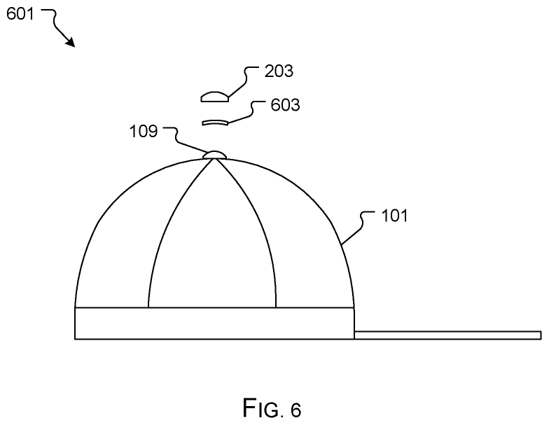

Referring now to FIG. 5 the preferred method of use of the system of FIG. 2 is depicted. Method 501 including selecting a customized indicia 503, placing the indicia on the top of the cover 505, pressing the cover over the top of a button of a cap 507 and locating a cap by the indicia on the cover 509.

It is further contemplated that in an alternative embodiment, as depicted by FIG. 6, that an adhesive layer 603 is placed between the cover 203 and the button 109. It will be understood that the adhesive layer 603 further facilitates the attachment of the cover 203 to the cap 101. It is contemplated that the adhesive layer 603 could include any method of bonding the cover 203 to the button 109.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed:

1. A headgear identification system comprising:
a cover having a body with the outer edge thereof curved back toward the center forming a wall; and
the wall having a lip thereon;
at least one indicia on the top of the body of the cover;
wherein the cover is secured to the button of cap via the lip on the wall.

2. The system of claim 1 wherein the cover is configured to attach to another feature of the cap or other headgear item.

3. The system of claim 1 wherein an adhesive layer is attached inside the cover and between the cover and the button.

4. The method of customizing a piece of headgear given the system of claim 1; comprising:
selecting a customized indicia;
placing the indicia on the top of the cover;
pressing the cover over the top of a button of a cap; and
locating a cap by the indicia on the cover.
